(19) United States
(12) Patent Application Publication
(10) Pub. No.: US 2008/0272202 A1
(43) Pub. Date: Nov. 6, 2008

(54) Methods and apparatus for assisting persons with remembering locations

(76) Inventor: Martha Morelos, Chicago, IL (US)

Correspondence Address: RYNDAK & SURI LLP, 200 W. MADISON STREET, SUITE 2100, CHICAGO, IL, 60606, US

(21) Appl. No.: 11/797,517

(22) Filed: May 4, 2007

(51) Int. Cl. B05B 12/02

(52) U.S. Cl. 239/70

(57) ABSTRACT

Methods and apparatus are provided for assisting people with remembering directions or specific locations, such as where a vehicle is parked in a parking garage. A device for automatically dispersing a scent is provided at the location. The scent may be provided in combination with an associated image, photograph, color scheme, sound or other indicia. The scent may be added to a portable item such as a paper ticket which a person may take as a reminder of the location.

### RELATED APPLICATION

This application claims the benefit of Provisional Application Ser. No. 60/796,036, filed Apr. 28, 2006.

### FIELD OF THE INVENTION

This application claims the benefit of Provisional Application Ser. No. 60/796,036, filed Apr. 28, 2006.

The present invention relates to assisting people with remembering directions or a specific location guided by the sense of smell aided by mechanical or electronic devices.

### BACKGROUND OF THE INVENTION

Various methods have been used to assist people with remembering directions or specific locations, such as the floor on which they parked their vehicle in a parking garage or the location of a room in a building. Some systems do not provide a sufficiently memorable reminder. Moreover, methods which rely solely on visual reminders are of no assistance to a person who is visually impaired, and those which rely solely on audible reminders cannot assist the hearing impaired. There is a need for a method to better assist people with remembering directions and locations.

While the present invention is susceptible of embodiments in various forms, there is shown in the drawings and will hereinafter be described some exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

### BRIEF SUMMARY OF THE INVENTION

In one form, the invention is a method and apparatus for locating vehicles in parking garages or other storage locations. The invention provides for assisting people with locating their parked or stored vehicle using scent and/or a combination of visual aids or other devices related to a specific location to help a person remember the direction of the specific location where the vehicle is parked. In one form, one or more of the following devices may be used in combination: images and/or photographs, color schemes, sounds, scents or smells, or any other device that may assist with remember the location of a vehicle parked in a parking garage or other storage structure. Different levels of the garage or storage structure may be identified, for example, by an image of different fruits for each parking garage level. In one form, for example, level five would have an image of a cherry visually imprinted in the elevator, stair or hallway portion along with a device for emitting the scent of cherries and level three may have an image of grapes accompanied by the scent of grapes. In some embodiments, the images of the fruit may also be accompanied by the written name of the fruit. See for example the attached drawing FIGS. 1-6 for an example of one embodiment.

It is understood that in other embodiments, a variety of different types of images of fruits, vegetables, flowers, desserts, perfumes or colognes, or images and descriptive word(s) of any other type of scent emitting objects can e used in place of the fruit images corresponding to the particular levels.

### BRIEF DESCRIPTION OF THE DRAWINGS

FIG. 1 is a view of an elevator lobby using the method and apparatus of the invention;

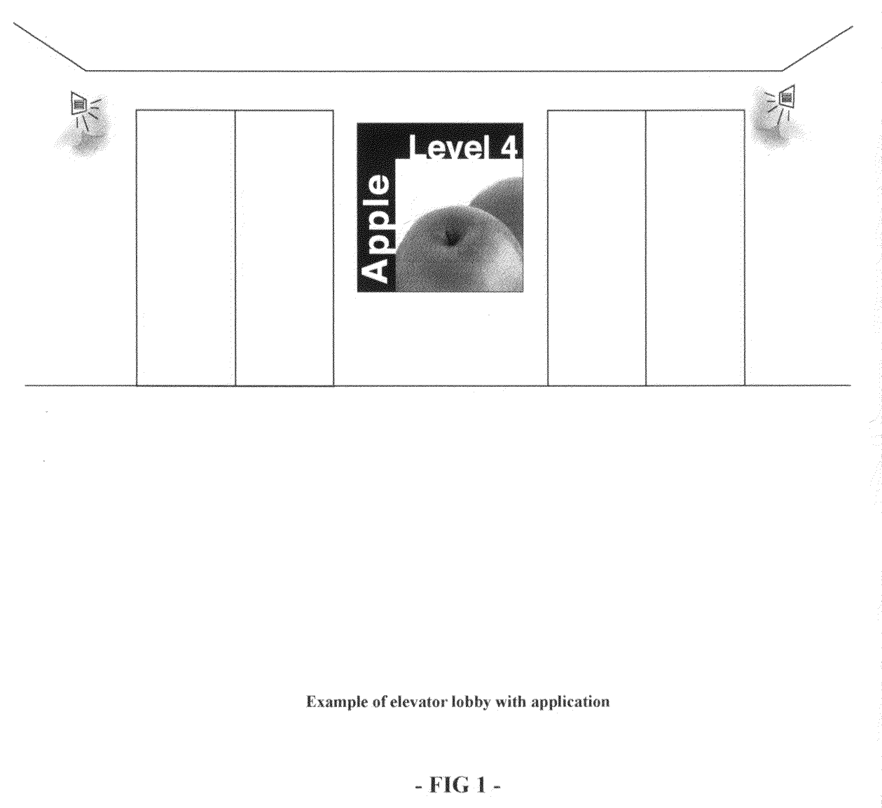

FIG. 2 is an example of a visual image used to identify a location in accordance with the invention;

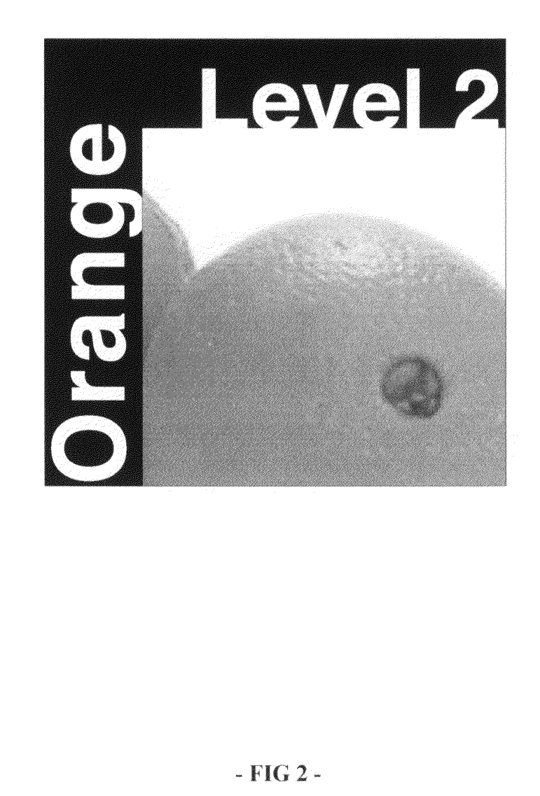

FIG. 3 is another example of a visual image used to identify a location in accordance with the invention;

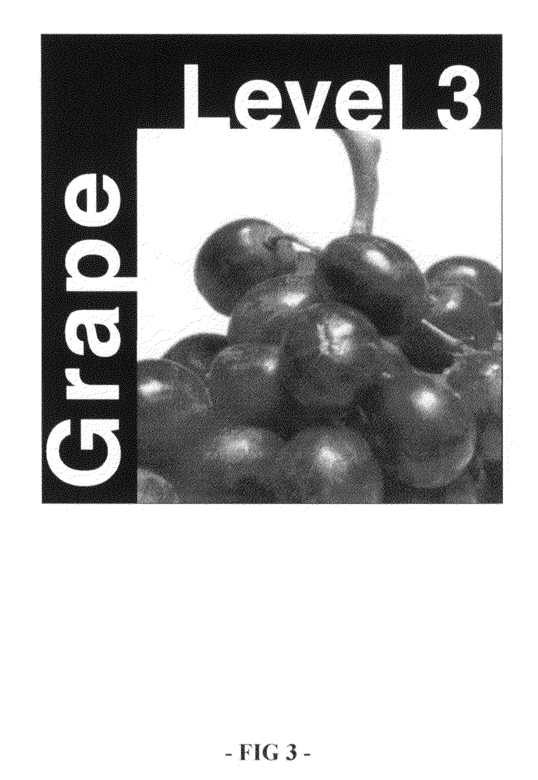

FIG. 4 is another example of a visual image used to identify a location in accordance with the invention;

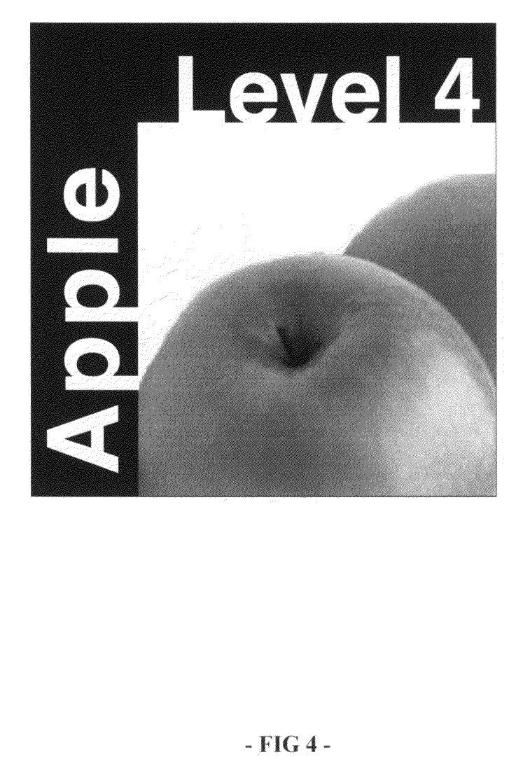

FIG. 5 is a visual image showing multiple images and associated locations of FIGS. 2-4; and

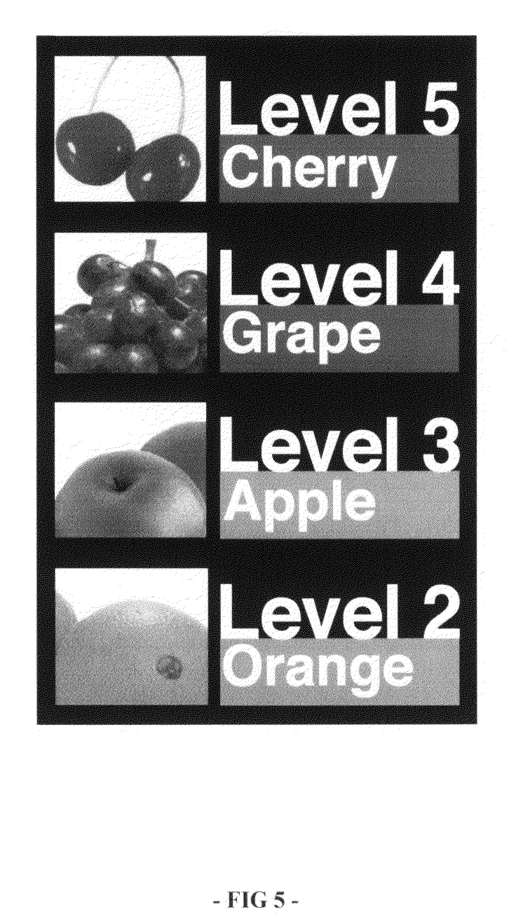

FIG. 6 is a representation of the locations with associated images of FIGS. 2-4.

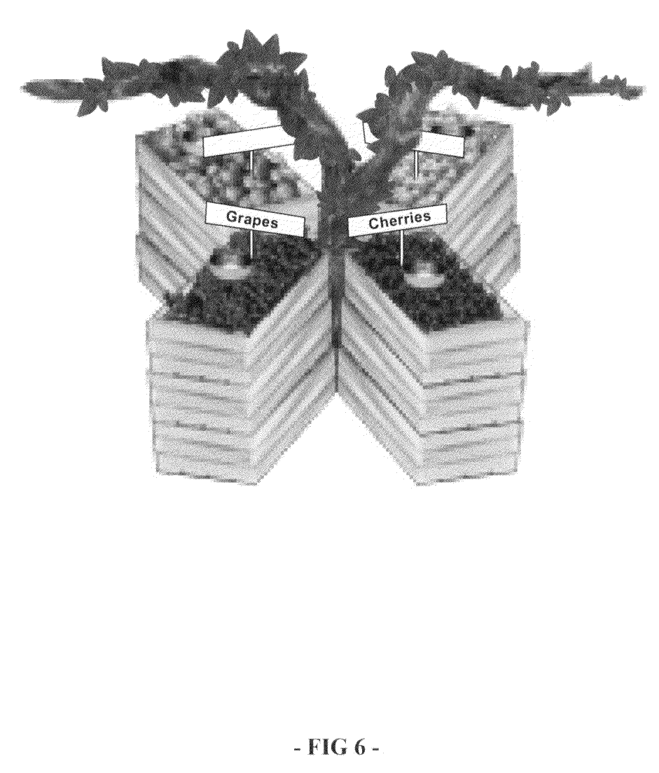

### DETAILED DESCRIPTION OF THE INVENTION

Referring to the figures generally, it is understood that in other embodiments, a variety of different types of images of fruits, vegetables, flowers, desserts, perfumes or colognes, or images and descriptive word(s) of any other type of scent-emitting objects can be used in place of the fruit images corresponding to the particular levels.

In one embodiment t, the images may be used in association with scent to facilitate a person remembering the location of their parked vehicle in a garage or location of a room in a building or other location in a venue. In one form, a scent-emitting or scent-spreading device may be used at each level or location to regularly maintain either at timed intervals or maintain constantly the scent associated with the images corresponding to the particular levels or locations. Any device, method or process that provides the appropriate amount of scent for an individual to smell the scent during their minimal time in that particular location will provide the necessary results. The device may be mechanical in nature and/or may encompass a variety of different electronics to facilitate the timing sequence of the omitted scent. In one form, the scent-emitting device may be activated when the person takes a ticket, pushes an elevator button, opens a door, interrupts a light sensor, etc. The scent itself may be in liquid, solid or gas form.

In yet other embodiments, to enable a person to remember the actual location of a vehicle, a scent applicator device can be provided and may activate to create a scent on an actual ticket or other paper item that the person would take with them when they leave the parking facility or venue. The device may be a ticket, a card or any other device that can maintain the specific applied scent for a period of time. For example, in one embodiment, a parking lot ticket validator can spray the specific scent on the ticket and print the level on the ticket to assist with identification of the particular level the user's vehicle is parked on.

In one embodiment, the invention may assist a variety of different people for a variety of different purposes with location of their vehicle or simply to facilitate finding locations or rooms within a structure, building or other facility. It may assist blind people, people identifying car locations in parking garages, and people trying to locate particular areas within a building, such as specific rooms. It can also be used in convention centers, museums, schools, airports, hospitals, shopping malls, supermarkets, public buildings, hotels, casinos, hallways, etc. In other applications, it may assist with finding locations in outdoor places such as amusement parks, cultural facilities, entertainment events, gardens, markets, etc.

Specific embodiments of novel methods and apparatus for construction of methods and apparatus for assisting persons with remembering locations according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations or equivalents that fall within the true spirit and scope of the basic underlying principles disclosed and claimed herein.

What is claimed is:

1. A method wherein the sense of smell is used as an effective way of determining or remembering the location of a person, object or place; where the scent, perfume or fragrance that guides the sense of smell is dispersed regularly or with time intervals by a mechanical or electronic device.

2. The method of claim 1 wherein a specific scent is related to specific images and themes that are graphically represented on the location and help to facilitate the process of remembering a location.

3. The method of claim 1 wherein the device that disperses the aroma could be composed by (should be “of”?) any kind of fragrance in a solid, liquid, gel or gas form that is distributed by a fan.

4. The method of claim 1 wherein the device that disperses the aroma could be composed of any kind of fragrance in a solid, liquid, gel or gas form that is distributed by an apparatus activated by electric current.

5. The method of claim 1 wherein the device that disperses the aroma could be composed of any kind of fragrance in a solid, liquid, gel or gas form that is distributed by an apparatus activated by natural or artificial heat.

6. A method as described in claim 1 wherein the device that disperses the aroma could be composed of any kind of fragrance in a solid, liquid, gel or gas form that is distributed by an apparatus that electronically or mechanically sprays the fragrance.

7. The method of claim 1 wherein the device that sprays the aroma is activated by a light or movement sensor.

8. The method of claim 1 wherein the device that sprays the aroma is activated by a mechanical action like open a door, taking a ticket or pushing an elevator button.

9. A method as described in claim 1 that is used to aid people impaired to see or to read as a system where specific scents are associated with specific situations and invite a specific response from the user.

10. A method as described in claim 1 wherein the scent is added to a paper ticket or any other item that can maintain the scent for a specific period of time, and such ticket or item may be taken by the person as a reminder of the area to be identified.

11. A method as described in claim 1 used to identify or facilitate the location of specific areas within a building such as convention centers, museums, airports, shopping centers, casinos, hotels, homes, hospitals, schools and hallways.

12. A method as described in claim 1 used to identify or facilitate the location of a vehicle in a parking garage.

13. A method as described in claim 1 used to identify or facilitate the location of specific areas outdoors such as amusement parks, festivals, forest preserves, picnic areas and public gardens.
